(19) United States
(12) Patent Application Publication
(10) Pub. No.: US 2017/0112116 A1
(43) Pub. Date: Apr. 27, 2017

(54) COMPUTER INTELLIGENT IMAGING-BASED SYSTEM FOR AUTOMATIC PEST IDENTIFICATION AND PEST-CATCHING MONITORING

(71) Applicant: SHANGHAI XINGRANG INDUSTRIAL CO., LTD., Shanghai (CN)

(72) Inventors: Yiqian Ji, Shanghai (CN); Hebin Ji, Shanghai (CN); Lihong Chen, Shanghai (CN)

(21) Appl. No.: 15/398,739

(22) Filed: Jan. 5, 2017

Related U.S. Application Data
(63) Continuation-in-part of application No. PCT/CN2014/087238, filed on Sep. 24, 2014.

(51) Int. Cl. A01M 1/14; A01M 1/08; G06K 9/00; B65G 49/02; H04N 7/18; H04N 5/33; A01K 29/00; A01M 1/10

(52) U.S. Cl. CPC A01M 1/145; A01K 29/00; A01M 1/08; A01M 1/106; B65G 49/02; H04N 7/183; H04N 5/33; G06K 9/00362; H04L 67/10

(57) ABSTRACT

A computer intelligent imaging-based system for automatic pest identification and pest-catching monitoring, including a pest-catching device, an imaging lens, an imaging control module, a power supply device, a data transmission module, a cloud data server, a pest identification module, a terminal control module and a data display module; the invention records the pest conditions and transmits the data to the cloud data server and the data display module, and further transmits the data to the terminal control module and the pest identification module to realize analysis, identification and remote monitoring of the species and quantity of the pests. It only takes only 6 minutes for 1 person to finish the works for 100 pest-catching devices and get through the steps of filing records and analyzing pests. Compared with the prior art, it saves 1 day of working time and significantly reduces the costs for maintenance and consumables.

### CROSS REFERENCE TO RELATED APPLICATIONS

The present application is a Continuation-In-Part Application of PCT application No. PCT/CN2014/087238 filed on Sep. 24, 2014. All the above are hereby incorporated by reference.

### TECHNICAL FIELD

The invention relates to an intelligent pest-catching device, and particularly to a computer intelligent imaging-based system for automatic pest identification and pest-catching monitoring.

### BACKGROUND ART

With 5 steps as changing adhering paper, checking and sorting pests, filling in record card, filing records and analyzing pests, the current sticking-type pest-catching device on the market consumes large quantity of labor and time. Thus, the maintenance cost for pest services in food processing and food related industries stays at a high level. For example, it takes 1 day for 1 technician to work on the steps of changing adhering paper, checking and sorting pests and filling in record card and takes 1 day for 1 technician to work on the steps of filing records and analyzing pests. In total, it takes 2 working days and consumes many unnecessary labor cost. Moreover, all of these procedures are finished by personnel (such as artificial field maintenance and artificial identification), causing a large difference between statistical data and real data; therefore, the statistical data cannot indicate the real status and risk of pests.

In addition, the suction air-flowing type adhering paper free pest-catching device currently on the market will cause higher labor cost for regular artificial field maintenance; meanwhile, all pests are gathered together by the device, failing to effectively count the species and quantities and resulting in inaccuracy data out of manual identification. Thus, most of these devices are deprecated for their limited functions.

### SUMMARY OF THE INVENTION

To solve the above technical problems, the invention discloses a computer intelligent imaging-based system for automatic pest identification and pest-catching monitoring, comprising a pest-catching device, an imaging lens, an imaging control module, a power supply device, a data transmission module, a cloud data server, a pest identification module, a terminal control module and a data display module; the imaging lens and the imaging control module are arranged on the pest-catching device; the imaging control module controls imaging, image processing and storage of the imaging lens; the power supply device is connected to the pest-catching device for power supply; the cloud data server and the data display module are respectively connected to the imaging control module through the data transmission module; the pest identification module and the terminal control module are respectively connected to the cloud data server; the imaging control module transmits the images to the cloud data server through the data transmission module; the cloud data server analyzes the images and transmits the analyzed data to the data display module.

As a further improvement of the Invention, the imaging lens comprises a video imaging lens, a picture-taking imaging lens and an infrared imaging lens.

As a further improvement of the Invention, the data transmission module comprises a 3G communication module and a WIFI wireless communication module for inter-transmission of images, data and instructions between the imaging control module, the data display module, the cloud data server and the terminal control module.

As a further improvement of the Invention, the cloud data server comprises a data storage module and a calculation module; the data storage module is used for storing the imaging data of the imaging lens and the input data of the terminal control module; the calculation module is used for classification calculation and summarizing calculation of imaging data, generation of data report and retrieval of database.

As a further improvement of the Invention, the pest identification module comprises two modes as artificial identification and automatic identification, which are used for pest species identification and counting.

As a further improvement of the Invention, the data display module comprises a display screen and a control chip; the display screen is used for displaying pest quantity, species, density and trend, operation condition of the pest-catching device and temperature, humidity and forewarning data; the control chip is used for controlling data displaying and operation condition of the display screen and input and retrieval of data command.

As a further improvement of the Invention, the terminal control module is used for data displaying, input and retrieval of the cloud data server, pest data query, viewing of system operation condition, real-time monitoring of pests and input of data and instructions.

As a further improvement of the Invention, the pest-catching device comprises a fixed board, a piece of adhering paper, a paper-feeding reel, a collecting reel, a holder for adhering paper, a UVA trap lamp, a lamp cover and a driving motor; the holder for adhering paper is arranged on the fixed board; the collecting reel is arranged below the paper-feeding reel; the adhering paper stretches out from the paper-feeding reel, winding on the holder for adhering paper and entering the collecting reel; the UVA trap lamp is arranged on the holder for adhering paper; the lamp cover is arranged on the fixed board; the driving mechanism is arranged on the back of the fixed board and connected to the collecting reel through a belt.

As a further improvement of the Invention, the imaging lens and the imaging control module are arranged below the holder for adhering paper and the data display module is arranged on the outer wall of the lamp cover.

As a further improvement of the Invention, the pest-catching device comprises a fixed backboard, a lamp cover and a glue-storing box, a UVA trap lamp and a bracket that are arranged in the lamp cover; the UVA trap lamp is arranged on the fixed backboard through the bracket and the glue-storing box is arranged below the UVA trap lamp.

As a further improvement of the Invention, the imaging lens and the imaging control module are arranged on the fixed backboard above the UVA trap lamp; the data display module is arranged on the outer wall of the lamp cover.

As a further improvement of the Invention, a rolling mechanism is arranged on the glue-storing box; the rolling mechanism comprises a conveyor belt, a first gear shaft, a second gear shaft, a third gear shaft and a driving motor; the conveyor belt passes through the first gear shaft, the second gear shaft and the third gear shaft in sequence and forms a sealed triangle; a part of the conveyor belt is immerged in the pest glue in the glue-storing box; the driving motor drives the conveyor belt to operate in cycle in and out of the glue-storing box.

As a further improvement of the Invention, the pest-catching device comprises a housing, and an automatic screening mechanism, an automatic cleaning mechanism arranged in the housing, and a trap lamp arranged above the housing; both sides of the housing are arranged with a pest-suction inlet and a pest discharging outlet; the automatic cleaning mechanism is arranged below the automatic screening mechanism; a mounting bracket is arranged at the bottom of the housing; a transparent self-cleaning explosion-proof lamp cover is arranged outside of the trap lamp; a metal protective net is arranged outside of the transparent self-cleaning explosion-proof lamp cover.

As a further improvement of the Invention, an imaging lens and an imaging control module are respectively arranged near the pest-suction inlet above the automatic screening mechanism and below the automatic screening mechanism; an infrared transceiver, a light sensor and a humidity sensor are arranged in the housing; the infrared transceiver, the light sensor and the humidity sensor are connected to the cloud data server through the data transmission module.

As a further improvement of the Invention, the automatic screening mechanism comprises a fixed part, a rotating part connected to the fixed part and a screening blade arranged on the fixed part; the screening blade is arranged with several meshes.

As a further improvement of the Invention, a stainless steel protective net is arranged along the outer extension of the pest-suction inlet; an inverted suction fan is arranged below the pest-suction inlet; a conical net passage is arranged below the inverted suction fan.

As a further improvement of the Invention, a solar panel is arranged above the trap lamp; a breakage-proof perspex sheet is arranged between the solar panel and the stainless steel protective net; a lightning rod is arranged above the solar panel.

The advantages of the invention are as follows:

The pest conditions are recorded through the imaging lens and the imaging control module in the Invention; the data is transmitted to the cloud data server and the data display module through the data transmission module and further transmitted to the terminal control module and the pest identification module; thus analysis, identification and remote monitoring of the pest species and quantities are realized. The Invention solves the technical defects of current products through the above intelligent imaging system. If using a pest-catching device installed with the intelligent imaging system, it only takes 6 minutes for 1 person to finish the works for 100 pest-catching devices and get through the steps of filing records and analyzing pests. Compared with the prior art, it saves 1 day of working time and significantly reduces the costs for maintenance and consumables, and enables the managers to remotely know the conditions of building sealing, sanitation and personnel specification on site, and thus brings more convenient management and economic benefits to enterprises authentically.

### BRIEF DESCRIPTION OF THE DRAWINGS

In order to illustrate the technical schemes in the embodiments of the invention more clearly, the drawings required in description of the embodiments will be introduced briefly as follows. Obviously, the drawings in the following description are just a part of the embodiments of the invention. A person skilled in the art is able to obtain other drawings according to these drawings without any creative work.

FIG. 1 is a structure principle diagram of the Invention;

FIG. 2 is a working principle diagram of the pest identification module of the invention;

FIG. 3 is a structure schematic diagram of the pest-catching device in Embodiment 1;

FIG. 4 is a schematic diagram of partial structure of the pest-catching device in Embodiment 1;

FIG. 5 is a schematic diagram of partial structure of the back of the pest-catching device in Embodiment 1;

FIG. 6 is a structure schematic diagram of the pest-catching device in Embodiment 2;

FIG. 7 is a schematic diagram of partial structure of the rolling mechanism in Embodiment 2;

FIG. 8 is a schematic diagram of partial structure of the side of the pest-catching device in Embodiment 2;

FIG. 9 is a structure schematic diagram of the pest-catching device in Embodiment 3;

FIG. 10 is a structure schematic diagram of the metal protective net in Embodiment 3;

FIG. 11 is a schematic diagram of partial structure of the automatic screening mechanism in Embodiment 3;

### MARKS IN THE FIGURES

100—pest-catching device; 101—fixed board; 102—adhering paper; 103—paper-feeding reel; 104—collecting reel; 105—holder for adhering paper; 106—UVA trap lamp; 107—lamp cover; 108—driving motor; 109—belt; 110—imaging lens; 111—imaging control module; 112—data display module;

200—pest-catching device; 201—fixed backboard; 202—lamp cover; 203—glue-storing box; 204—UVA trap lamp; 205—bracket; 206—conveyor belt; 207—first gear shaft; 208—second gear shaft; 209—third gear shaft; 210—driving motor; 211—imaging lens; 212—imaging control module; 213—data display module;

300—pest-catching device; 301—housing; 302—trap lamp; 303—pest-suction inlet; 304—pest discharging outlet; 305—mounting bracket; 306—transparent self-cleaning explosion-proof lamp cover; 307—metal protective net ; 308—imaging lens; 309—imaging control module; 310—infrared transceiver; 311—light sensor; 312—humidity sensor; 313—fixed part; 314—rotating part; 314a—first triangle stop; 314b—second triangle stop; 314c—dialing block; 315—screening blade; 316—stainless steel protective net; 317—inverted suction fan; 318—conical net passage; 319—solar panel; 320—breakage-proof perspex sheet; 321—lightning rod.

### DETAILED DESCRIPTION OF THE PREFERRED EMBODIMENTS

A clear and full description of the technical schemes of the embodiments of the invention will be given in combination of the drawings of the embodiments of the invention as follows. Obviously, the described embodiments are just a part rather than the whole of the embodiments of the invention.

### Embodiment 1

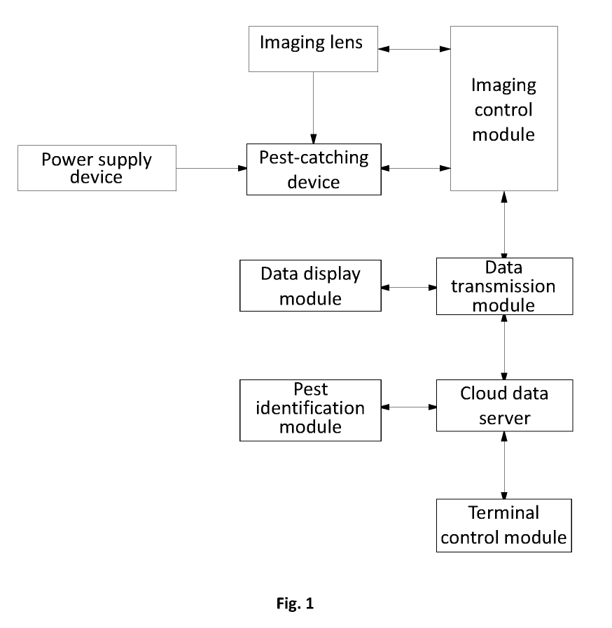

As shown in FIG. 1, the computer intelligent imaging-based system for automatic pest identification and pest-catching monitoring of the Embodiment comprises a pest-catching device, an imaging lens, an imaging control module, a power supply device, a data transmission module, a cloud data server, a pest identification module, a terminal control module and a data display module.

The imaging lens and the imaging control module are arranged on the pest-catching device; an intelligent chip is arranged in the imaging control module to mainly control imaging time and effect of the imaging lens, and processing, compressing, storage and transmission of images.

The imaging lens comprises a video imaging lens, a picture-taking imaging lens and an infrared imaging lens; the video imaging lens makes video, which will be cut into images through processing by the imaging control module and transmitted to the cloud data server; the picture-taking imaging lens takes pictures and transmits them to the cloud data server; the infrared imaging lens forms images through the infrared lens and transmits them to the cloud data server.

Different imaging lenses shall be equipped based on different environment. The picture-taking imaging lens can be installed for general environment; the video imaging lens can be installed in case a real-time monitoring is needed for a target area and the infrared imaging lens can be installed in case the images are formed in a dark environment at night.

The power supply device is connected to the pest-catching device for power supply; the power supply device can either be of AC power or solar power; the solar power supply is mainly used in the places where AC power is not available.

The cloud data server and the data display module are respectively wireless connected to the imaging control module through the data transmission module. The cloud data server comprises a data storage module and a calculation module; the data storage module is used for storing the imaging data of the imaging lens and the input data of the terminal control module; the calculation module is used for classification calculation and summarizing calculation of imaging data, generation of data report and retrieval of database.

The data display module comprises a display screen and a control chip; the display screen is used for displaying pest quantity, species, density and trend, operation condition of the pest-catching device and temperature, humidity and forewarning data; the control chip is used for controlling data displaying and operation condition of the display screen and input and retrieval of data command.

The data transmission module comprises a 3G communication module and a WIFI wireless communication module for inter-transmission of images, data and instructions between the imaging control module, the data display module, the cloud data server and the terminal control module.

The terminal control module comprises a PC terminal and a mobile terminal such as computer, cellphone and tablet, etc.; it is mainly used for data displaying, input and retrieval of the cloud data server, pest data query, viewing of system operation condition, real-time monitoring of pests and input of data and instructions.

The pest identification module and the terminal control module are respectively connected to the cloud data server; the imaging control module transmits the images to the cloud data server through the data transmission module; the cloud data server analyzes the images and transmits the analyzed data to the data display module.

The pest identification module comprises two modes as artificial identification and automatic identification. Artificial identification is to transmit the pest images to the cloud data server and read the images through the terminal control module and then input the identification result into the terminal control module and store it in the cloud data server after the pest species and quantities are identified by a technician.

The function of automatic identification shall be realized with the help of software. The invention develops a kind of identification software with a kernel algorithm of identification and counting of pest species based on computer vision/image identification/neural network/pattern identification/deep learning technologies. The development of the identification software comprises the following procedures of:

I. Establishing a training database for pest identification and counting and evaluation system is to:

Establish training database for pest identification; collect pest specimens of different distribution density for marking; mark the pests need to be counted for model training and learning. More abundant data in the database, more accurate forecasted result will be obtained. Moreover, the training data is expandable. The data can be added constantly with the deepening of the project to upgrade the depth model.

Develop a scientific evaluation system for solutions and establish a standard format of forecasted data to realize automatic assessment and statistics of the algorithm results, comprising establishing distributions of different density, testing data set in different conditions and developing scientific evaluation indicators (e.g., mean absolute error, average variance and error in the environment of different density of different and overall species of pests). Select a proper solution for different application environment through establishment of evaluation system and horizontal assessment and comparison of related algorithms.

II. Training depth learning model for pest classification counting

Depth learning model uses the method of depth leaning to realize pest identification and counting and establish a multi-layer network model. It automatically obtains an estimation model of distribution density of pests through training the abundant marked data and obtains the quantity of different pests in the area through the integral of density distribution in corresponding area. Wherein, the model structure, parameter initialization and objective function design use GoogLenet network and VGG network to describe, classify and count the pests and build a bridge for the field gap between the input images and the forecasted value through designing the object function and the method for information transmission.

For the algorithm framework of depth learning model of pest classification and counting, the model is input with the specimen of pest collecting board to output the true value density diagram of different pests obtained according to the marked information. Collect image blocks randomly in the specimen and collect the density true value of the corresponding position in the true value density diagram and the corresponding quantity of different pests and then obtain a corresponding model through training the depth model with the method of mini-batch back propagation.

III. Cross-platform pest identification and counting system development is to

Optimize and package the algorithm based on the determined kernel algorithm to improve the calculating speed of the algorithm so that it can adapt to different platforms; form a releasable SDK (software development kit) through sorting and optimization of the kernel algorithm to embed it into the database system and develop apps for PC and mobile platforms and from a software system. Realize full automation and intellectualization of pest identification technology in combination with the terminal device of pest identification technology and update statistical information to PC and mobile platforms in real time through the server.

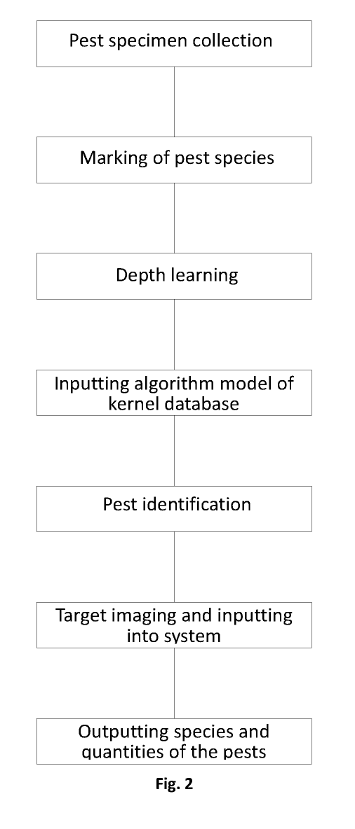

Combined with the above identification software, the pest identification module can identify the species of the pests and count the number of each species. As shown in FIG. 2, the working principle mainly comprises the following steps of: pest specimen collection—marking of pest species—depth learning—inputting algorithm model of kernel database—pest identification—target imaging and inputting into system—outputting species and quantities of the pests.

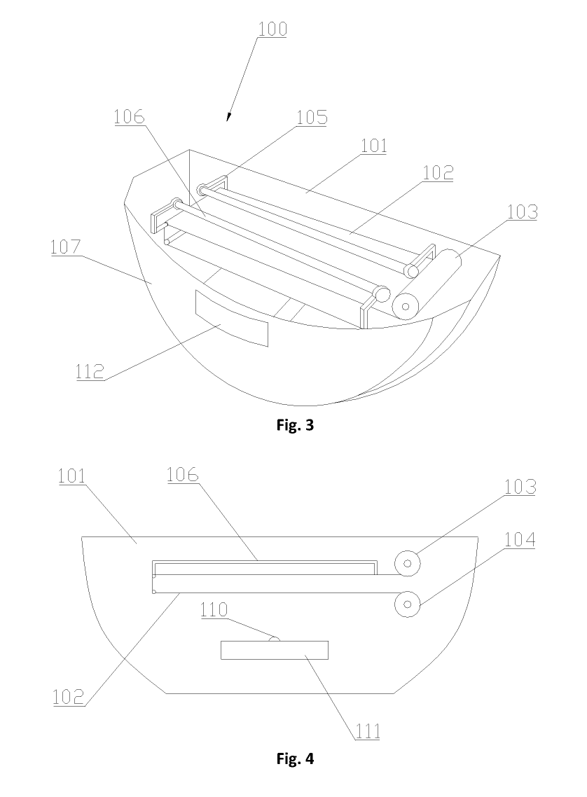

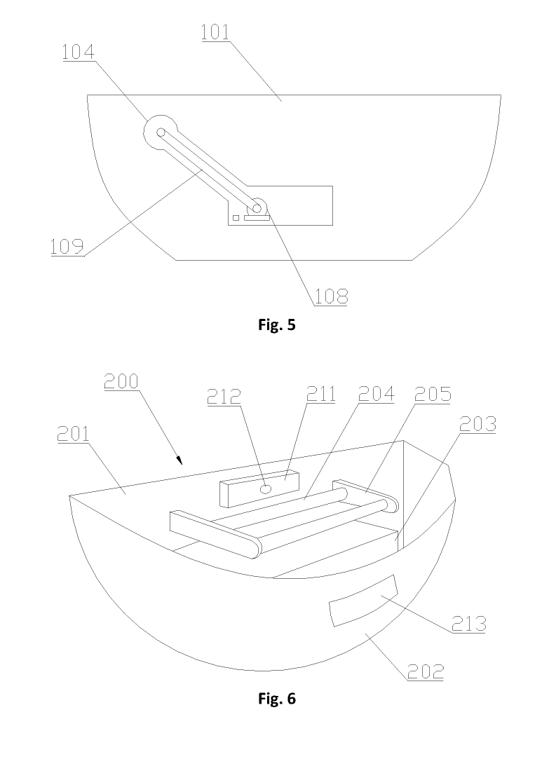

As shown in FIGS. 3-5, the pest-catching device 100 comprises a fixed board 101, a piece of adhering paper 102, a paper-feeding reel 103, a collecting reel 104, a holder for adhering paper 105, a UVA trap lamp 106, a lamp cover 107 and a driving motor 108.

The holder for adhering paper 105 is arranged on the fixed board 101; the collecting reel 104 is arranged below the paper-feeding reel 103; the adhering paper 102 stretches out from the paper-feeding reel 103, winding on the holder for adhering paper 105 and entering the collecting reel 104;

The UVA trap lamp 106 is arranged on the holder for adhering paper 105; the lamp cover 107 is arranged on the fixed board 101; the driving motor 108 is arranged on the back of the fixed board 101 and connected to the collecting reel 104 through a belt 109; the imaging lens 110 and the imaging control module 111 are arranged below the holder for adhering paper 105 and the data display module 112 is arranged on the outer wall of the lamp cover 107.

After pests are stuck onto the adhering paper 102, the driving motor 108 drives the collecting reel 104 to rotate, rolling the adhering paper 102 with the pests to the corresponding position of the imaging lens 110 below the holder for adhering paper 105; the imaging lens 110 shoots the pests and transmits the images of pests to the cloud data server and the pest identification module through the data transmission module for data storage and calculation and pest identification and counting, and then transmits the pest data to the data display module 112 and the terminal control module so that it can be viewed and managed by technical personnel.

### Embodiment 2

The computer intelligent imaging-based system for automatic pest identification and pest-catching monitoring in the Embodiment has the same structure and working principle with those described in Embodiment 1 except for the pest-catching device.

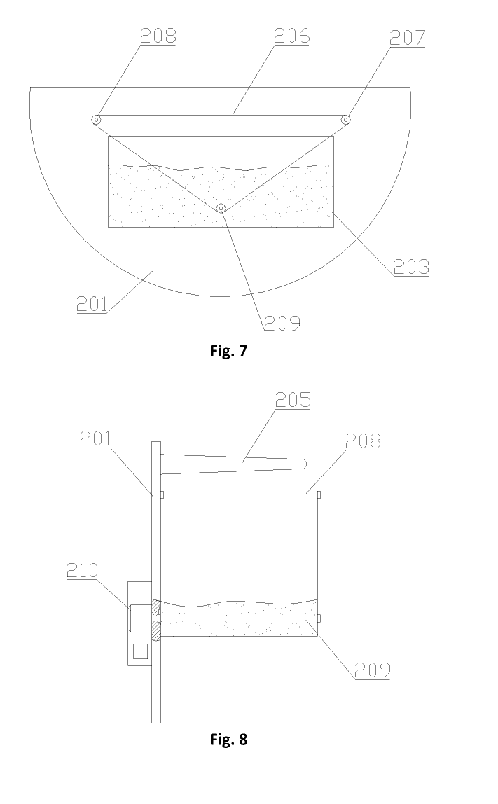

As shown in FIGS. 6-8, the pest-catching device 200 of the Embodiment comprises a fixed backboard 201, a lamp cover 202 and a glue-storing box 203, a UVA trap lamp 204 and a bracket 205 that are arranged in the lamp cover 202; the UVA trap lamp 204 is arranged on the fixed backboard 201 through the bracket 205 and the glue-storing box 203 is arranged below the UVA trap lamp 204.

A rolling mechanism is arranged on the glue-storing box 203; the rolling mechanism comprises a conveyor belt 206, a first gear shaft 207, a second gear shaft 208, a third gear shaft 209 and a driving motor 210. The conveyor belt 206 passes through the first gear shaft 207, the second gear shaft 208 and the third gear shaft 209 in sequence and forms a sealed triangle; a part of the conveyor belt 206 is immerged in the pest glue in the glue-storing box 203; the driving motor 210 drives the conveyor belt 206 to operate in cycle in and out of the glue-storing box 203.

The imaging lens 211 and the imaging control module 212 are arranged on the fixed backboard 201 above the UVA trap lamp 204; the data display module 213 is arranged on the outer wall of the lamp cover 202.

After pests are stuck onto the conveyor belt 206, the imaging lens 211 shoots the pests and transmits the images of pests to the cloud data server and the pest identification module through the data transmission module for data storage and calculation and pest identification and counting, and then transmits the pest data to the data display module 213 and the terminal control module so that it can be viewed and managed by technical personnel.

### Embodiment 3

The computer intelligent imaging-based system for automatic pest identification and pest-catching monitoring in the Embodiment has the same structure and working principle with those described in Embodiment 1 except for the pest-catching device.

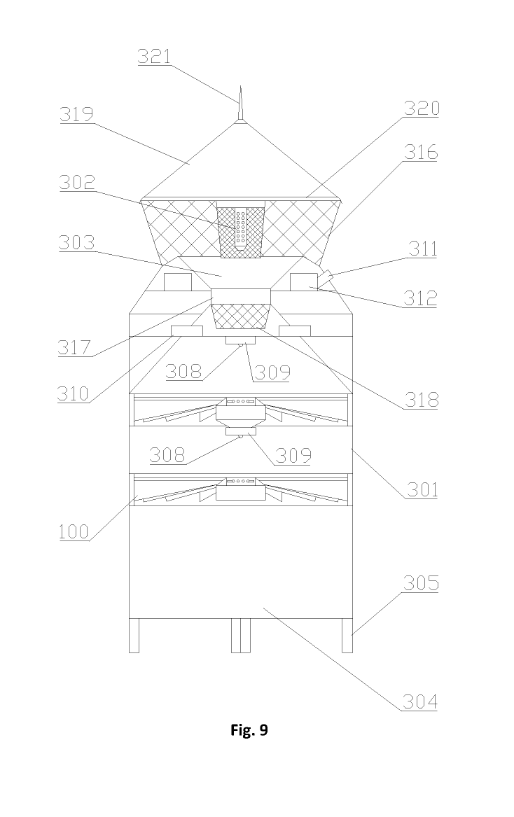

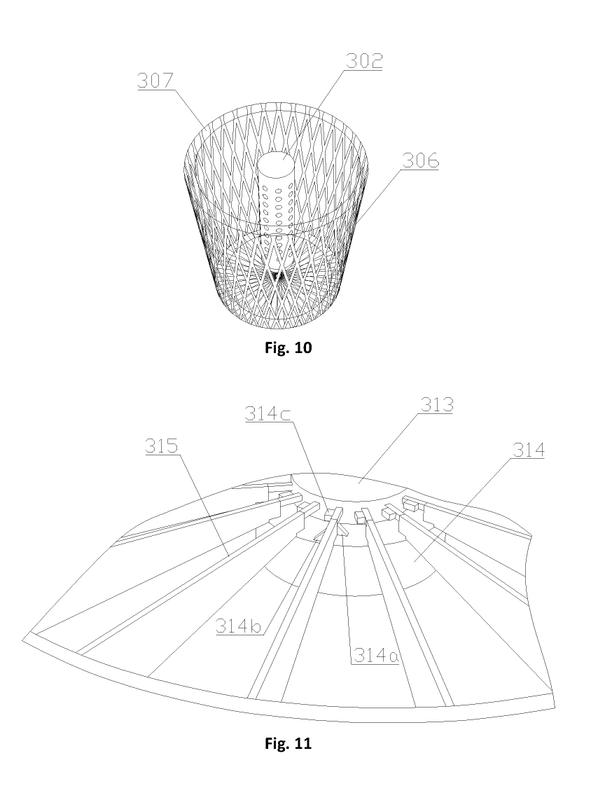

As shown in FIGS. 9-11, the pest-catching device 300 of the Embodiment comprises a housing 301, an automatic screening mechanism, an automatic cleaning mechanism arranged in the housing 301, and a trap lamp 302 arranged above the housing 301; both sides of the housing 301 are arranged with a fly-suction inlet 303 and a fly-exhaust outlet 304. The automatic cleaning mechanism is arranged below the automatic screening mechanism; a mounting bracket 305 is arranged at the bottom of the housing 301; a transparent self-cleaning explosion-proof lamp cover 306 is arranged outside of the trap lamp 302; a metal protective net 307 is arranged outside of the transparent self-cleaning explosion-proof lamp cover 306.

An imaging lens 308 and an imaging control module 309 are respectively arranged near the pest-suction inlet 303 above the automatic screening mechanism and below the automatic screening mechanism; an infrared transceiver 310, a light sensor 311 and a humidity sensor 312 are arranged in the housing 301; the infrared transceiver 310, the light sensor 311 and the humidity sensor 312 are connected to the cloud data server through the data transmission module.

The automatic screening mechanism comprises a fixed part 313, a rotating part 314 connected to the fixed part 313 and a screening blade 315 arranged on the fixed part 313; the screening blade 315 is arranged with several meshes.

A first triangle stop 314a and a second triangle stop 314b are arranged on the rotating part 314 with an interval equals to the thickness of the screening blade 315; a dialing block 314c is arranged on the screening blade 315 corresponding to the first triangle stop 314a; when the rotating part 314 rotates clockwise for a round, the dialing block 314c will be blocked by the first triangle stop 314a and the screening blade 315 will be opened and erected one by one so that the pest could fall down into the automatic cleaning mechanism; when the rotating part 314 rotates anticlockwise for a round, the screening blade 315 will be blocked by the second triangle stop 314b and then fold and lay flat one by one and go on to catch pests.

A stainless steel protective net 316 is arranged along the outer extension of the pest-suction inlet 303; an inverted suction fan 317 is arranged below the pest-suction inlet 303; a conical net passage 318 is arranged below the inverted suction fan 317.

A solar panel 319 is arranged above the trap lamp 302; a breakage-proof perspex sheet 320 is arranged between the solar panel 319 and the stainless steel protective net 317; a lightning rod 321 is arranged above the solar panel 319.

The pests will be induced to nearby the trap lamp 302 and sucked into the automatic screening mechanism by the suction flow generated by the inverted suction fan 317. When the pests fall down into the automatic cleaning mechanism, the infrared transceiver 310 will monitor the process and record the quantity and the size of the pests.

The imaging lens 308 shoots the pests in the automatic screening mechanism and the automatic cleaning mechanism at regular intervals and transmits the images of pests to the cloud data server and the pest identification module through the data transmission module for data storage and calculation and pest identification and counting, and then transmits the pest data to the data display module and the terminal control module so that it can be viewed and managed by technical personnel.

The light sensor 311 and the humidity sensor 312 are used for perceiving the changing of light intensity and humidity of the environment; the light sensor 311 can control the working hours of the pest-catching device 300 and power up at dark; the humidity sensor 312 can control the pest-catching device 300 to stop working in raining days.

The pest conditions are recorded through the imaging lens and the imaging control module in the invention; the data is transmitted to the cloud data server and the data display module through the data transmission module and further transmitted to the terminal control module and the pest identification module; thus analysis, identification and remote monitoring of the pest species and quantities are realized. The invention solves the technical defects of current products through the above intelligent imaging system. If using a pest-catching device installed with the intelligent imaging system, it only takes 6 minutes for 1 person to finish the works for 100 pest-catching devices and get through the steps of filing records and analyzing pests. Compared with the prior art, it saves 1 day of working time and significantly reduces the costs for maintenance and consumables, and enables the managers to remotely know the conditions of building sealing, sanitation and personnel specification on site, and thus brings more convenient management and economic benefits to enterprises authentically.

The above are the preferred embodiments rather than the limitations of the Invention. Any amendment, equivalent replacement and improvement made within the range of the spirit and rule of the Invention shall be included in the protection scope of the Invention.

What is claimed is:

1. A computer intelligent imaging-based system for automatic pest identification and pest-catching monitoring, comprising:
a pest-catching device, an imaging lens, an imaging control module, a power supply device, a data transmission module, a cloud data server, a pest identification module, a terminal control module and a data display module; wherein the imaging lens and the imaging control module are arranged on the pest-catching device; the imaging control module controls imaging, image processing and storage of the imaging lens; the power supply device is connected to the pest-catching device for power supply; the cloud data server and the data display module are respectively wireless connected to the imaging control module through the data transmission module; the pest identification module and the terminal control module are respectively connected to the cloud data server; the imaging control module transmits the images to the cloud data server through the data transmission module; the cloud data server analyzes the images and transmits the analyzed data to the data display module.

2. The computer intelligent imaging-based system for automatic pest identification and pest-catching monitoring according to claim 1, wherein, the imaging lens comprises a video imaging lens, a picture-taking imaging lens and an infrared imaging lens.

3. The computer intelligent imaging-based system for automatic pest identification and pest-catching monitoring according to claim 2, wherein, the data transmission module comprises a 3G communication module and a WIFI wireless communication module for inter-transmission of images, data and instructions between the imaging control module, the data display module, the cloud data server and the terminal control module.

4. The computer intelligent imaging-based system for automatic pest identification and pest-catching monitoring according to claim 3, wherein, the cloud data server comprises a data storage module and a calculation module; the data storage module is used for storing the imaging data of the imaging lens and the input data of the terminal control module; the calculation module is used for classification calculation and summarizing calculation of imaging data, generation of data report and retrieval of database.

5. The computer intelligent imaging-based system for automatic pest identification and pest-catching monitoring according to claim 4, wherein, the pest identification module comprises two modes as artificial identification and automatic identification, which are used for pest species identification and counting.

6. The computer intelligent imaging-based system for automatic pest identification and pest-catching monitoring according to claim 5, wherein, the data display module comprises a display screen and a control chip; the display screen is used for displaying pest quantity, species, density and trend, operation condition of the pest-catching device and temperature, humidity and forewarning data; the control chip is used for controlling data displaying and operation condition of the display screen and input and retrieval of data command.

7. The computer intelligent imaging-based system for automatic pest identification and pest-catching monitoring according to claim 6, wherein, the terminal control module is used for data displaying, input and retrieval of the cloud data server, pest data query, viewing of system operation condition, real-time monitoring of pests and input of data and instructions.

8. The computer intelligent imaging-based system for automatic pest identification and pest-catching monitoring according to claim 7, wherein, the insect-catching device comprises a fixed plate, a piece of adhering paper, a paper-feeding reel, a collecting reel, a holder for adhering paper, a UVA trap lamp, a lamp cover and a driving motor; the holder for adhering paper is arranged on the fixed plate; the collecting reel is arranged below the paper-feeding reel; the adhering paper stretches out from the paper-feeding reel, winding on the holder for adhering paper and entering the collecting reel; the UVA trap lamp is arranged on the holder for adhering paper; the lamp cover is arranged on the fixed plate; the driving mechanism is arranged on the back of the fixed plate and connected to the collecting reel through a belt.

9. The computer intelligent imaging-based system for automatic pest identification and pest-catching monitoring according to claim 8, wherein, the imaging lens and the imaging control module are arranged below the holder for adhering paper and the data display module is arranged on the outer wall of the lamp cover.

10. The computer intelligent imaging-based system for automatic pest identification and pest-catching monitoring according to claim 7, wherein, the pest-catching device comprises a fixed backboard, a lamp cover and a glue-storing box, a UVA trap lamp and a bracket that are arranged in the lamp cover; the UVA trap lamp is arranged on the fixed backboard through the bracket and the glue-storing box is arranged below the UVA trap lamp.

11. The computer intelligent imaging-based system for automatic pest identification and pest-catching monitoring according to claim 10, wherein, the imaging lens and the imaging control module are arranged on the fixed backboard above the UVA trap lamp; the data display module is arranged on the outer wall of the lamp cover.

12. The computer intelligent imaging-based system for automatic pest identification and pest-catching monitoring according to claim 11, wherein, a rolling mechanism is arranged on the glue-storing box; the rolling mechanism comprises a conveyor belt, a first gear shaft, a second gear shaft, a third gear shaft and a driving motor; the conveyor belt passes through the first gear shaft, the second gear shaft and the third gear shaft in sequence and forms a sealed triangle; a part of the conveyor belt is immerged in the pest glue in the glue-storing box; the driving motor drives the conveyor belt to operate in cycle in and out of the glue-storing box.

13. The computer intelligent imaging-based system for automatic pest identification and pest-catching monitoring according to claim 7, wherein, the pest-catching device comprises a housing, and an automatic screening mechanism, an automatic cleaning mechanism arranged in the housing, and a trap lamp arranged above the housing; both sides of the housing are arranged with a pest-suction inlet and a pest discharging outlet; the automatic cleaning mechanism is arranged below the automatic screening mechanism; a mounting bracket is arranged at the bottom of the housing; a transparent self-cleaning explosion-proof lamp cover is arranged outside of the trap lamp; a metal protective net is arranged outside of the transparent self-cleaning explosion-proof lamp cover.

14. The computer intelligent imaging-based system for automatic pest identification and pest-catching monitoring according to claim 13, wherein, an imaging lens and an imaging control module are arranged near the pest-suction inlet above the automatic screening mechanism and below the automatic screening mechanism respectively; an infrared transceiver, a light sensor and a humidity sensor are arranged in the housing; the infrared transceiver, the light sensor and the humidity sensor are connected to the cloud data server through the data transmission module.

15. The computer intelligent imaging-based system for automatic pest identification and pest-catching monitoring according to claim 14, wherein, the automatic screening mechanism comprises a fixed part, a rotating part connected to the fixed part and a screening blade arranged on the fixed part; the screening blade is arranged with several meshes.

16. The computer intelligent imaging-based system for automatic pest identification and pest-catching monitoring according to claim 15, wherein, a stainless steel protective net is arranged along the outer extension of the pest-suction inlet; an inverted suction fan is arranged below the pest-suction inlet; a conical net passage is arranged below the inverted suction fan.

17. The computer intelligent imaging-based system for automatic pest identification and pest-catching monitoring according to claim 16, wherein, a solar panel is arranged above the trap lamp; a breakage-proof perspex sheet is arranged between the solar panel and the stainless steel protective net; a lightning rod is arranged above the solar panel.
